(19) United States
(12) Patent Application Publication
(10) Pub. No.: US 2025/0300359 A1
(43) Pub. Date: Sep. 25, 2025

(54) CHANNEL ESTIMATION IN A RECONFIGURABLE INTELLIGENT SURFACE USING SUBSTRATE INTEGRATED WAVEGUIDES

(71) Applicant: Dell Products L.P., Round Rock, TX (US)

(72) Inventors: Navjot Kaur Khaira, Kanata (CA); Tejinder Singh, Kanata (CA)

(21) Appl. No.: 18/613,388

(22) Filed: Mar. 22, 2024

(51) Int. Cl. H01Q 15/00; H01P 1/00; H01P 3/12

(52) U.S. Cl. CPC H01Q 15/002; H01P 1/00; H01P 3/121

(57) ABSTRACT

The technology described herein is directed towards a reconfigurable intelligent surface design and implementation in which a small portion of the incoming signal energy of an impinging wave is coupled to a waveguide, with the majority of the signal reflected in a desired target direction. The captured portion of the signal energy is used for evaluating the channel in the current environment, including by assessing the phase and amplitude of the sampled signal at each unit cell, as well as their differential phase values between cells, e.g., selected consecutive cells. For example, the differential phase values between cells can be used to accurately estimate the direction/location of the signal transmitter and/or the intended receiver(s). In one implementation, the captured portion of the energy is coupled to a substrate integrated waveguide at the unit cell level, and output as a signal readout for determining different characteristics of the signal.

### BACKGROUND

Reconfigurable intelligent surfaces (alternatively referred to as intelligent reflective surfaces, or metasurfaces) are manmade thin reflective or refractive surfaces whose electromagnetic response can be electronically controlled. Reconfigurable intelligent surfaces are characterized by their two-dimensional arrays of electronically controllable reflecting elements that can dynamically manipulate electromagnetic waves by altering attributes such as phase, amplitude, and direction of the incoming signal. Because of their ability to alter the attributes of signals reflected at the surface, intelligent reflective surfaces are being evaluated for use in beyond fifth generation (B5G) and sixth generation (6G) wireless communication and wireless sensing networks.

In communications assisted by a reconfigurable intelligent surface, the real-time conditions of the channel/signal environment at the array of elements often can change. Knowing such real-time conditions of the channel/signal environment allows adapting the reconfigurable intelligent surface based on this information. However, prior approaches to obtain such information have significant drawbacks, including the need to add dedicated receiving antennas and a huge number of radio frequency chains, while also reducing the overall effective surface of the reconfigurable intelligent surface, and/or not being extendable to non-line-of-sight communications or low ambient light scenarios.

### BRIEF DESCRIPTION OF THE DRAWINGS

The technology described herein is illustrated by way of example and not limited in the accompanying figures in which like reference numerals indicate similar elements and in which:

FIG. 1 is an example conceptual block diagram showing an example system that includes a unit cell of a reconfigurable intelligent surface for reflecting an incoming electromagnetic signal while sensing a portion of the incoming signal energy, in accordance with various example embodiments and implementations of the subject disclosure.

FIG. 2 is a three-dimensional representation of an example unit cell that includes a substrate integrated waveguide for capturing a portion of an incoming electromagnetic signal's energy, in accordance with various example embodiments and implementations of the subject disclosure.

FIG. 3 is enlarged three-dimensional representation of the example unit cell of FIG. 2, depicting an internal part of the substrate integrated waveguide, in accordance with various example embodiments and implementations of the subject disclosure.

FIG. 4 is a three-dimensional representation of an example unit cell that includes a substrate integrated waveguide, in which some side vias of the substrate integrated waveguide are not visible so as to illustrate an internal part of the substrate integrated waveguide, in accordance with various example embodiments and implementations of the subject disclosure.

FIG. 5 is a three-dimensional representation of an example reconfigurable intelligent surface, with an enlarged representation of one corner of the reconfigurable intelligent surface, and which also depicts a representation of part of a unit cell in that corner, in accordance with various example embodiments and implementations of the subject disclosure.

FIG. 6 is a graphical representation of simulated phase of a reflected signal around the operational frequency of 28 GHz, as varied with the change in capacitance of varactor, in accordance with various example embodiments and implementations of the subject disclosure.

FIG. 7 is a graphical representation of the magnitude of the reflected signal, and the magnitude of the signal coupled to a substrate integrated waveguide, for different varactor capacitances, in accordance with various example embodiments and implementations of the subject disclosure.

FIG. 8 is a top view representation of an example reconfigurable intelligent surface, showing how information collected from electrical sensing contacts of unit cells can be used to determine an angle of arrival of the incoming signal, in accordance with various example embodiments and implementations of the subject disclosure.

FIG. 9 is a graphical representation showing simulated differential phase values along a 16×1 array of elements of a reconfigurable intelligent surface, in accordance with various example embodiments and implementations of the subject disclosure.

FIGS. 10A-10E are block diagram representations of examples of estimating angles of arrival based on sampled phase data used to determine phase differential data, in accordance with various example embodiments and implementations of the subject disclosure.

FIG. 11 is a flow diagram showing example operations related to obtaining signal readouts from electrical sensing contacts of unit cells, and determining an angle of arrival of an incoming electromagnetic signals based on the signal readouts, in accordance with various example embodiments and implementations of the subject disclosure.

### DETAILED DESCRIPTION

The technology described herein is generally directed towards a reconfigurable intelligent surface with an integrated capability to acquire information about the propagation environment, such as the direction/location of the transmitter and the intended receiver(s). To this end, unit cells of the reconfigurable intelligent surface acquire the channel information by extracting a small portion of the incoming signal, and using the extracted signal portion to get valuable signal information, without sacrificing most of the signal power to be reflected towards the intended targets. In practical usage scenarios, the capability of obtaining the signal information allows for the accurate steering of wireless signals to desired areas, such as for enhancing the coverage in shadowed or traditionally weak signal zones. Such a reconfigurable intelligent surface beamforms a reflected signal in a passive way by varying the unit cells' phases to redirect incoming energy towards specific users or regions, without the need for active components, unlike traditional beamforming that requires phased array antennas, which can be complex and power consuming.

In one implementation, at the unit cell level in a reconfigurable intelligent surface, a small portion of the incident wave is coupled to a substrate integrated waveguide. A wide variety of significant channel information can be acquired by studying the phase and amplitude of this sampled incident signal at each unit cell, as well as their differential values between cells, e.g., consecutive cells. Substrate integrated waveguides offer the benefit of easy integration into conventional semiconductor and printed circuit board fabrication techniques. In this way, a small amount of an incoming signal is coupled to the substrate integrated waveguide, which can be output to study different characteristics of the signal. Note that the amount of coupled energy into the substrate integrated waveguide, and at the signal readout, can be adjusted during design of a reconfigurable intelligent surface.

One highly desirable result is a reconfigurable intelligent surface with integrated sensing capability that can detect the direction of incoming electromagnetic signals, and based on that information, more intelligently redirect the incoming signals in the direction of intended targets, based on acquiring knowledge of from where the signals originated. The technology described herein accomplishes this by capturing and evaluating a small portion of the incoming signals, while also reflecting most of the power to reflect the incoming signals in various ways as appropriate.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some practical limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

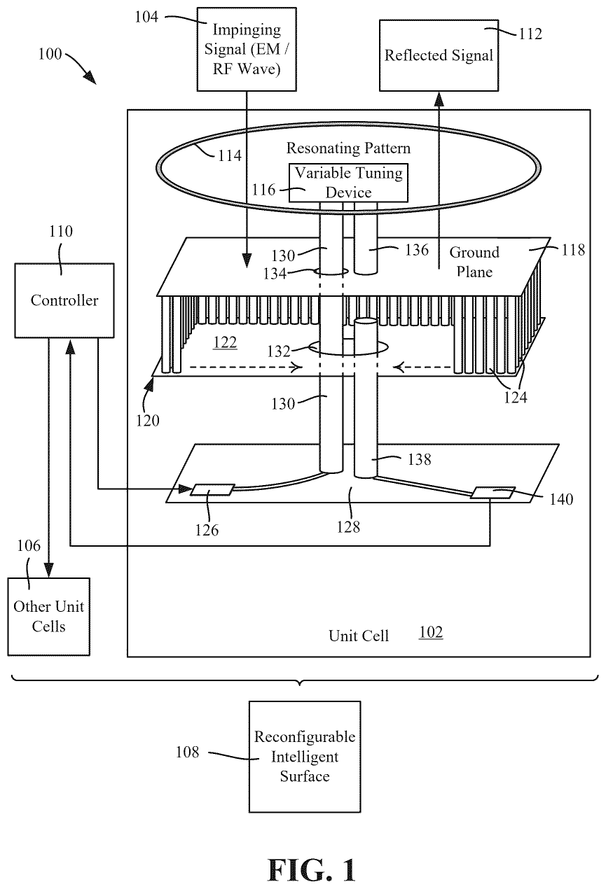

FIG. 1 is a conceptual depiction of an example system 100 including a unit cell 102 that redirects (reflects or refracts) an impinging (incoming) signal 104, while also capturing a portion of the incoming signal energy and providing a signal readout sensed from the captured portion of energy. The unit cell 102, in conjunction with other unit cells 106, form a reconfigurable intelligent surface 108.

The reconfigurable intelligent surface 108 is coupled to or otherwise incorporates a controller 110 that controls the phase shifts of the unit cell 102 and the other unit cells 106. This allows the incoming electromagnetic wave/signal 104 to be redirected (reflected or refracted) as a beam 112 that can be shaped and steered in a desired direction. However, to do so intelligently, having real time or near real-time information of the channel (e.g., incoming signal angle of arrival and magnitude of the incoming electromagnetic wave) is highly beneficial. Described herein is a reconfigurable intelligent surface framework that can infer the direction of the incident beams and thus steer them, e.g., in the reflection half space. To this end, the unit cells of the reconfigurable intelligent surface 108 have the ability to extract a fragment of the incident wave for channel study, while reflecting most of the incident wave, thereby ensuring sufficient reflective power and a modifiable reflective phase for the formation of optimal reflection configurations.

In one implementation, the unit cell 102 includes a resonating pattern 114 of metallic elements, such as including a ring-shaped resonator configured to resonate when the incoming electromagnetic (EM)/radio frequency (RF) wave 104 is impinging on the unit cell 102, such as an RF signal near or within the millimeter wavelength, e.g., (above 25 gigahertz). In general, the metallic resonating pattern 114 is designed to resonate at a frequency that corresponds to the frequency of the incoming signal. As set forth herein, a unit cell 102 can have a resonating pattern 114 of any suitable shape (e.g., square, rectangular, concentric ring-shape, coupled circles and so on) that resonates at a corresponding frequency of the incoming signal, and is thus not limited to any particular pattern. Note that in the examples herein, a unit cell 102 is designed for operation at 28 GHz; notwithstanding, the technology described herein can be easily extended to other frequency ranges.

In general, the metallic resonating pattern 114 is designed for operation at a desired resonance frequency that corresponds to the frequency of the incoming signal 104. A variable tuning device 116 (e.g., surface mounted inside the resonating pattern's ring, which can be a varactor, a PIN diode, an array of fixed capacitors, an array of fixed inductors, or a capacitance tuning device with the capability of changing the capacitance of the unit cell 102) is designed for operation at the desired resonance frequency, with a change in capacitance of the variable tuning device 116 determined by bias voltage as applied by the controller 110. The change in capacitance makes the phase of the unit cell 102 reconfigurable. In this way, each unit cell such as the unit cell 102 is capable of offering a reconfigurable phase to the incoming EM signal when provided with different voltage levels to the variable tuning device 116. When the phases of the individual unit cells are appropriately chosen and voltage-controlled by the controller 110 via the variable tuning device 116, the various phases modify the reflected electromagnetic wave, such as to result in constructive interference in a desired reflection direction. Note that such a varactor can be integrated into the unit cell, or can be a commercial product coupled (e.g., surface mounted) to the unit cell. Further, instead of or in addition to varactors, integrated tuning can be accomplished with PIN diodes, as well as any mechanism that can tune a unit cell's phase.

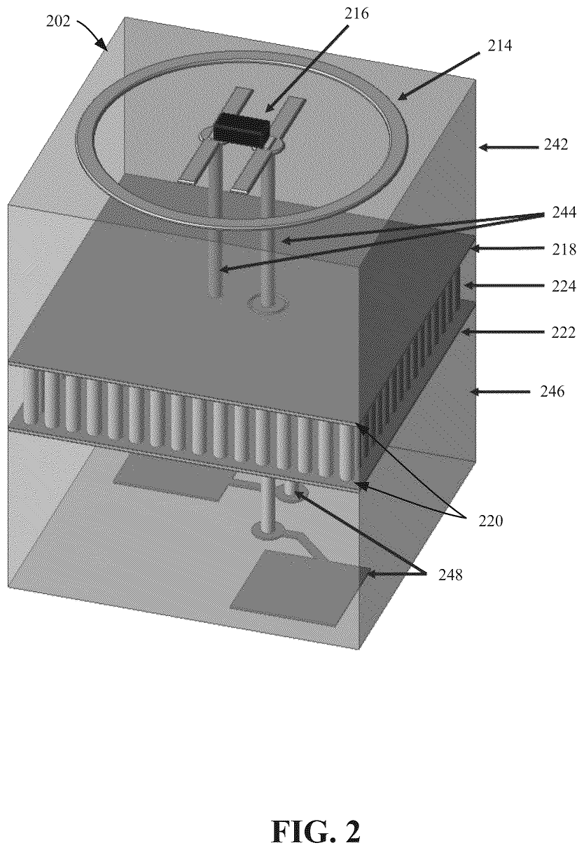

Also represented in FIG. 1 is the ground plane 118 of the unit cell 102. In one implementation, the ground plane 118 also acts as the top surface of a substrate integrated waveguide 120. As described with reference to FIGS. 2-4, the substrate integrated waveguide 120 captures a portion of the energy of the incoming EM signal.

The substrate integrated waveguide 120 includes a metal bottom layer 122, with the interior of the substrate integrated waveguide 120 enclosed by metal side vias (collectively 124), which are configured (based on the signal's wavelength) as separated metal-filled via holes, or sidewalls, with respect to not letting the portion of the incoming EM signal leak out. Note that some of the side vias in the front view of the substrate integrated waveguide 120 have been intentionally omitted to help view the interior of the substrate integrated waveguide 120; the left and right dashed arrows inside the substrate integrated waveguide 120 are intended to convey that the metal side vias 124 fully extend across the front side, as do the metal side vias 124 on the other sides.

To provide bias voltage to the variable tuning device 116, the controller 110 is coupled to a DC voltage contact 126, shown in the drawings as a pad on a bottom layer 128 of the unit cell 102. A voltage or current via 130 extends through a lower opening 132 of the metal bottom layer 122 of the substrate integrated waveguide 120, and through an upper opening 134 in the ground plane 118 (the upper metal layer of the of the substrate integrated waveguide 120), to supply positive bias voltage from the DC voltage contact 126 to a positive terminal of the variable tuning device 116. The varactor's negative terminal terminates at the ground plane by way of the via/conductor 136.

To obtain the information from the portion of the signal energy captured by the substrate integrated waveguide 120, an RF-coupled via probe 136 extends into the substrate integrated waveguide 120 through the bottom opening 132. This picks up at least some of the portion of the EM energy, and provides the picked up energy as electrical output to an electrical sensing contact 140/(e.g., in the form of a pad) to serve as an EM-coupled signal readout. As described herein, this readout is used in obtaining (learning) channel information related to the incoming signal 104.

FIGS. 2-4 provide additional, three-dimensional views and details of a unit cell 202 of a reconfigurable intelligent surface, which shows the components in a stack of metallic layers and dielectric layers. In FIGS. 2-4, in general labeled components that are similar to those of the conceptual depiction of FIG. 1 are labeled 2xx instead of 1xx.

Thus, as shown in FIG. 2, a reflective element pattern 214 and a varactor 216 (representative of one example type of the variable tuning device 116 of FIG. 1) are shown at the top of the unit cell 202 stack, supported by a top dielectric substrate 242. The vias for varactor biasing are collectively labeled 244; (note that the unit cell stack can be reoriented such that what can be seen as the left and right bias vias in FIG. 1 can be reversed).

The ground metal layer 218 is beneath the top dielectric substrate 242, and in this example implementation also serves as the top of the substrate integrated waveguide 220. The metal hole/sidewall vias 224 of the substrate integrated waveguide 220 are vertically oriented between the ground metal layer 218 and the bottom metal layer 222 of the substrate integrated waveguide 220. These layers are supported by a bottom substrate 246.

A substrate integrated waveguide is essentially a waveguide that is integrated into a dielectric substrate. Substrate integrated waveguides are a form of transmission line used in microwave and millimeter-wave circuits. They effectively bridge the gap between conventional rectangular waveguides and planar circuits. A substrate integrated waveguide is bounded by two parallel metal plates (top 218 and bottom 222), with the sides of the top plate 218 typically perforated with an array of metal-filled via holes. The via holes facilitate the inclusion of the metal side vias 224 that act as sidewalls of the waveguide, confining the electromagnetic waves between them. Substrate integrated waveguides offer several advantages over the conventional waveguides, including that they enable waveguide structures to be incorporated into standard planar circuit technologies, making them suitable for compact and integrated circuit designs. By integrating the waveguide into the substrate, substrate integrated waveguides structures can be fabricated using conventional printed circuit board (PCB) or semiconductor manufacturing techniques. Additionally, they can operate over a wide frequency range, including at high frequencies such as millimeter wave frequencies, making them suitable for various applications.

As also shown in FIG. 2, the metal contacts/pads for the varactor DC bias to the varactor and the EM signal and are collectively labeled 248. These pads 248 are beneath (at least in part) the bottom substrate 246 to facilitate straightforward external electrical coupling thereto.

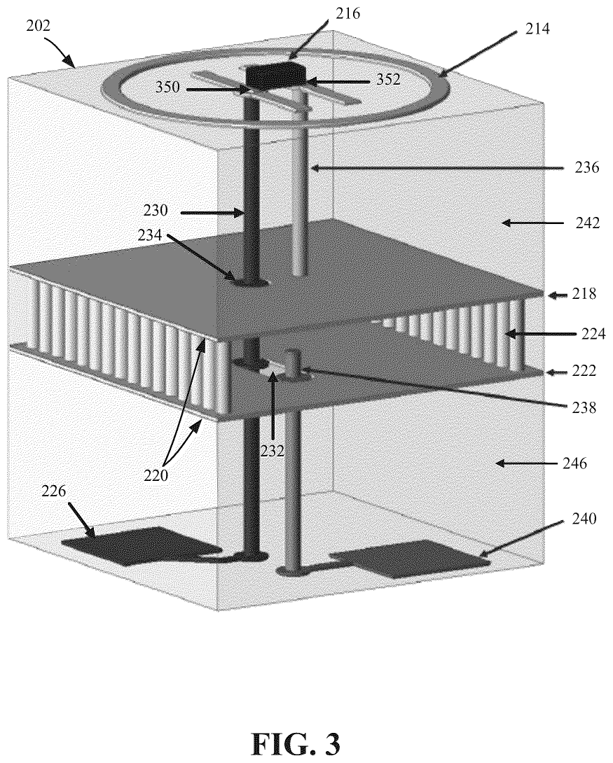

FIG. 3 is another three-dimensional view of the unit cell 202 of FIG. 2, in which some of the sidewalls 224 are omitted to allow the inside of the substrate integrated waveguide 220 to be viewed. As can be seen, most of the labeled components correspond to those described with reference to FIGS. 1 and 2, and in general are not described again for purposes of brevity. Note, however, that unlike FIGS. 2, the inside of the substrate integrated waveguide 220 is visible, and therefore shows the coupled via probe 238 extending into the substrate integrated waveguide 220 through the bottom opening 232.

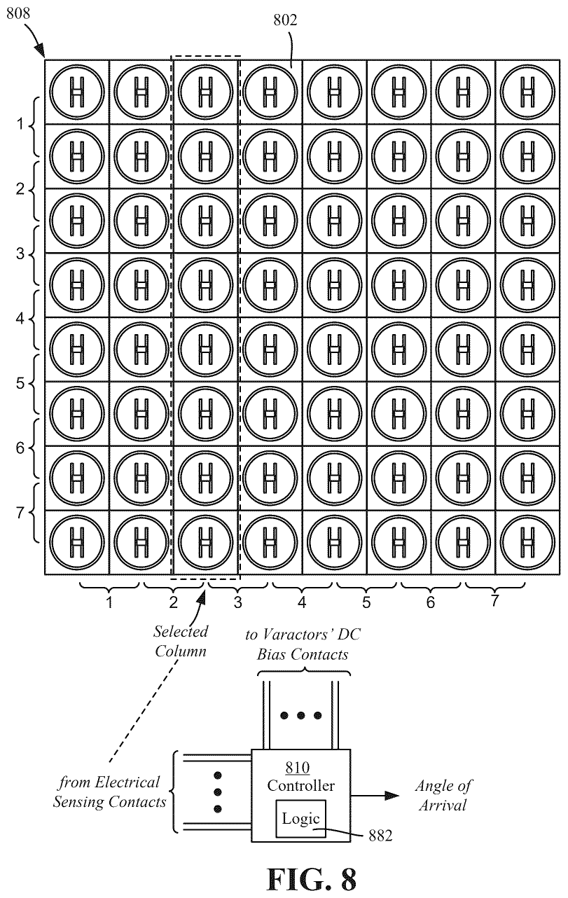

In general, substrate integrated waveguides channel the sampled signal, and have advantages over alternatives. For example, unlike microstrips, substrate integrated waveguides confine electromagnetic waves within their boundaries, minimizing potential interference. Furthermore, the intersection of vias with microstrips can induce unintended radiation, a scenario counterproductive for a unit cell design. Still further, the level of coupling between the substrate integrated waveguides and the meta-atom can be adjusted by modifying the substrate integrated waveguide's cutoff frequency, or by altering the distance from the via to the substrate integrated waveguide's edges. As described with reference to FIGS. 8-10, the amplitude of the sampled signal at each reconfigurable intelligent surface element and the differential phase between consecutive array elements are used to extract useful information about the incoming signal.

FIG. 3 also shows the positive and negative terminal locations 350 and 352, respectively, of the varactor 216. Further, in FIG. 3, the DC bias voltage pad 226 and the electrical sensing contact (EM coupled signal readout pad) 240 are shown as positioned at a layer level separated from the substrate integrated waveguide's bottom metal plate 222 by the dielectric substrate 246.

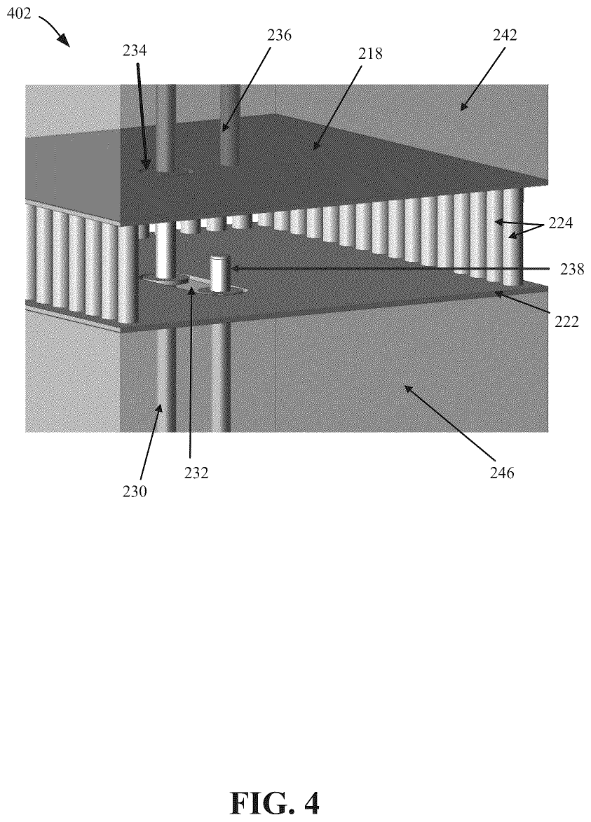

FIG. 4 is an enlarged view of a section 402 of the substrate integrated waveguide of FIG. 3, highlighting the coupled via probe 238. In one implementation, the reconfigurable intelligent surface ground plane 218 acts as the top metal plane for the substrate integrated waveguide structure, which is enclosed by another metal layer 222 separated by a dielectric 246, as well as enclosed on the sides by the metal vias 224. Under the influence of the incoming signal, the EM energy flows through the via 230 of the varactor 214 (FIG. 3). Some of the energy is coupled to the substrate integrated waveguide 220 when the via 230 passes through it.

The varactor via 230, which passes through the ground plane 218 is disconnected from ground by an annular slot 234. This annular slot allows for RF coupling of the incident wave to the substrate integrated waveguide structure. The coupled signal is read/sensed at the output by the coupled via probe 238. The extent of RF coupling can be fine-tuned by varying the annular slot's diameter and the characteristic dimensions of the coupling waveguide. In other words, the probe can be designed at a specific certain distance position/distance to capture part of signal; note that a probe is only one suitable coupling mechanism, and need not be a via as shown in the examples.

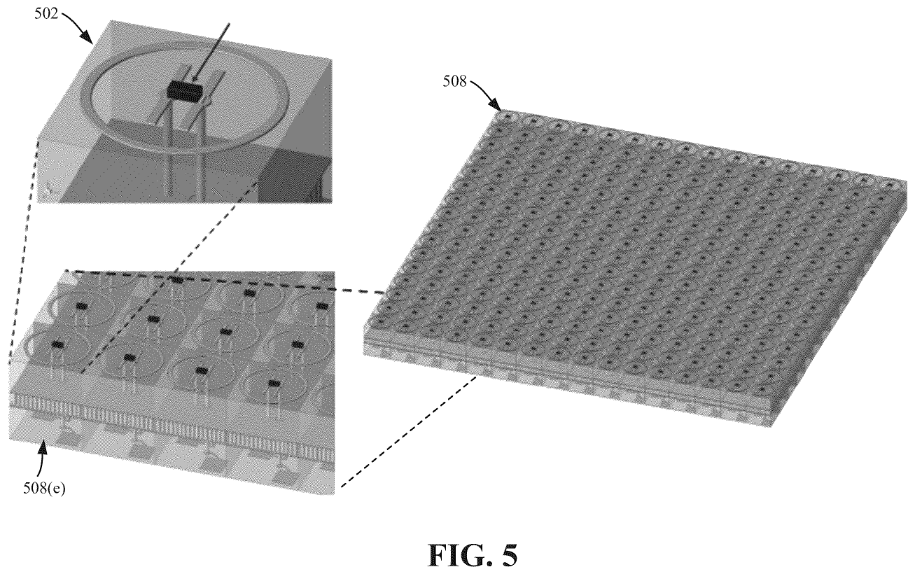

The reconfigurable intelligent surface is formed by arranging multiple unit-cells in a 2D m×n array. A 3D view of a reconfigurable intelligent surface 508 with 16 rows and 16 columns is shown in FIG. 5. An enlarged view 508 (e) from a section of the reconfigurable intelligent surface 508, is shown to highlight the geometry. FIG. 5 also shows the enlarged partial view of a unit cell 502, to better illustrate the reflective element patterned on the metallic layer on top substrate, each loaded with a surface mount varactor diode. One or more PIN diodes can also be used to the vary phase of a unit cell.

The element size and the spacing between elements are around a half wavelength. Using a smaller element size and spacing (for example around a quarter of wavelength or even smaller) can allow for better approximation of the necessary phase profile and improve beam redirecting performance, at the cost of larger interelement coupling and increased fabrication costs due to smaller feature sizes and tighter fabrication tolerances. In many cases, half wavelength provides an adequate middle ground for realizing the beam steering performance while keeping the fabrication costs low.

As is understood, to obtain the desired reconfigurable reflection, an electromagnetic wave at a resonance frequency within the operational band is transmitted to impinge on the unit cells. The reflected wave is modulated through varactor capacitance adjustments.

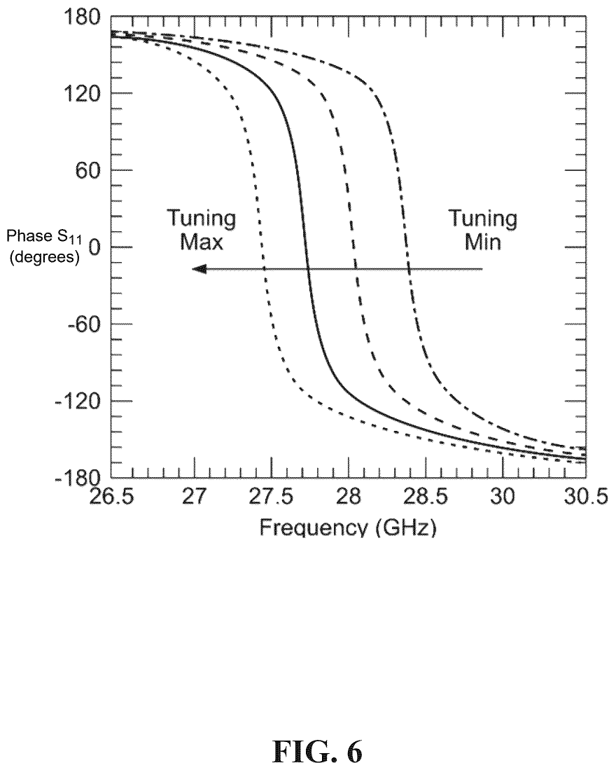

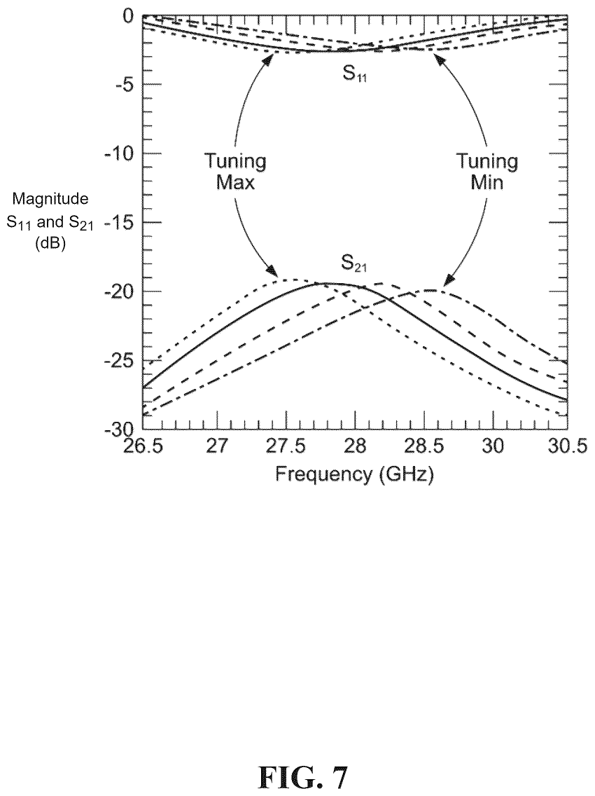

FIG. 6 shows the simulated phase of a reflected signal around the operational frequency of 28 GHz, with the change in capacitance of a varactor from a tuning minimum to a tuning maximum based on varying bias voltage. FIG. 7 graphically shows the magnitude of the reflected signal, and the signal portion coupled to the substrate integrated waveguide for different capacitance values.

To obtain the data for the graphs, the performance of unit cell was simulated using an industry standard 3D full-wave EM simulation tool. The way a unit cell reflects and passes on signals demonstrates how the reconfigurable intelligent surface works with electromagnetic waves. Based on the simulation results in FIGS. 6 and 7, the unit cell's reflection and signal's interaction with the substrate integrated waveguide through scattering parameters can be assessed. In FIG. 6, the S₁₁ phase responses show the reflective phase variations when adjusting the varactor's capacitance, which is needed for reconfigurable intelligent surface to precisely direct the reflected signal.

In FIG. 7, the S₁₁ magnitude with varying capacitance tuning highlights the reflection from the reconfigurable intelligent surface element, while the S₂₁ magnitude indicates the signal's interaction with the substrate integrated waveguide. Significantly, the magnitude of the coupled signal S₂₁ remains under-19 dB for all capacitance values in the varactor tuning range. Simultaneously, the reflection coefficient's magnitude S₁₁ stays above-3 dB. A suitable balance between the magnitudes of the reflected signal and the coupled signal to the substrate integrated waveguide can be determined for various scenarios, to ensure accurate channel assessment while retaining effective reflection towards intended targets by the reconfigurable intelligent surface.

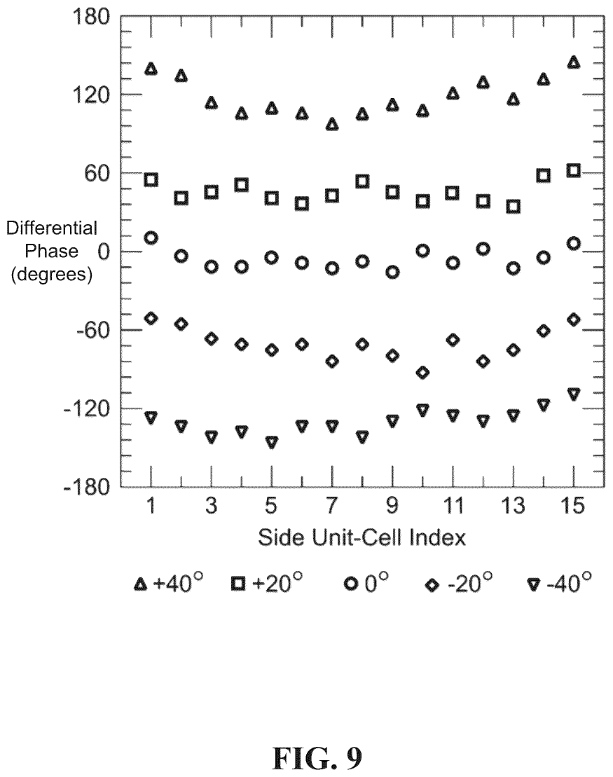

FIG. 8 is a top view representation of an 8×8 array 808 of sixty-four unit cells generally corresponding to the example unit cells of FIGS. 2-4. One of the unit cells 802 is labeled. As represented in FIG. 8, a controller 810 is coupled to provide respective varactor biasing voltages to the respective unit cells' bias contacts coupled to the respective varactors. Further, the controller 810 includes or is coupled to logic 882 that evaluates the EM coupled signal readouts from the electrical sensing contacts of the unit cells. As described with reference to FIG. 9, among other information the EM coupled signal readouts can be used to determine the angle of arrival of the incoming EM signal. This can be done by evaluating the phase differential values between at least some adjacent pairs of unit cells, represented in FIG. 8 by the row labels 1-7 and the column labels 1-7. For example, for any row or column, the phase differential values between the fields sampled by the first and second substrate integrated waveguides is labeled as ‘1’, between the second and third substrate integrated waveguides of two adjacent unit cells is labeled as ‘2’, and so on.

FIG. 9 graphically shows the simulated differential phase along the reconfigurable intelligent surface array of 16×1 elements for the incoming wave at five different incident angles. More particularly, to illustrate how the technology described herein can deduce information about a reconfigurable intelligent surface's incoming signal/channel, a row of sixteen elements was selected (note that FIG. 8 depicts a selected column of eight elements, however the principle is the same).

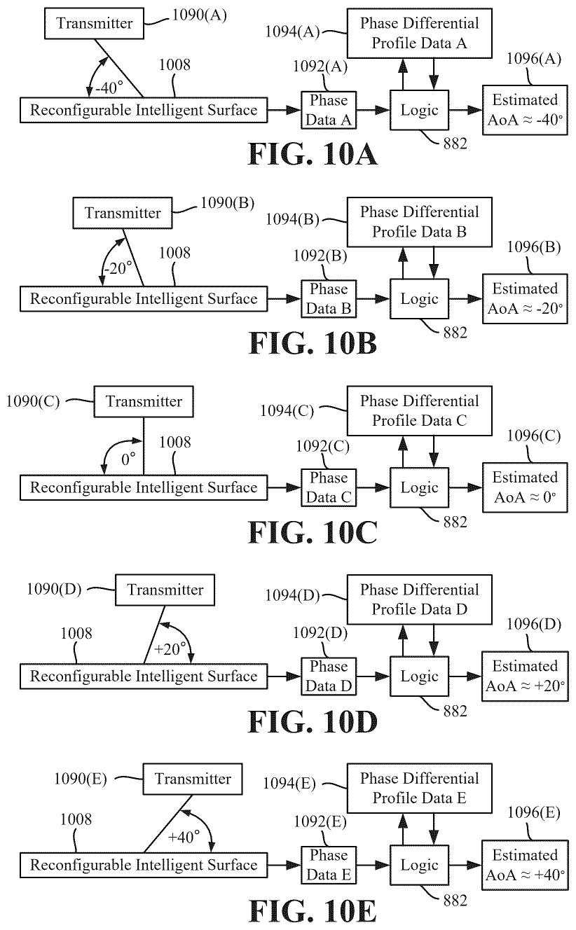

FIGS. 10A-10E show examples of different angles of arrival of differently positioned transmitters 1090(A)-1090(E), respectively, relative to a reconfigurable intelligent surface 1008 of unit cells. As described herein, the different angles of arrival (AoA) result in different phase data 1092(A)-1092(E) being obtained from the unit cells, which is processed by logic 882 into different phase differential profile datasets 1094(A)-1094(E), respectively. Based on the different phase differential profile datasets 1094(A)-1094(E), as generally described with reference to FIG. 9, the logic 882 determines the estimated angles of arrival 1096(A)-1096(E), respectively

To obtain the results shown in FIG. 9, the phase differences in S₂₁ were simulated between pairs of consecutive elements for the incoming wave at different angles. For instance, as with FIG. 8, the measurement labeled ‘2’ in FIG. 9 indicates the phase disparity between the fields sampled by the second and third substrate integrated waveguides of the unit cells in the selected row. As can be seen in FIG. 9, the phase difference varies based on the incident angle of the incoming wave, and is relatively linear for a given angle. The phase differences for a row (or column) can be averaged or otherwise combined to map to a more particular angle of arrival estimate, and the phase differences for more than one row or column can be evaluated. Although only five angles of arrival were simulated, other angles of arrival can be measured or simulated to obtain phase differential profiles that indicate what the angle of arrival is. Interpolation between the phase differences of two simulated or known for angles of arrival also can be used to estimate phase differences for angles of arrival between those two.

Other factors, such as the strength of the incoming wave can also be studied from the magnitude of S₂₁. In any event, the sampled signals obtained from the substrate integrated waveguides integrated with the unit cells in the reconfigurable intelligent surface architecture can be used to extract valuable information regarding the signals hitting the reconfigurable intelligent surface.

It should be noted that more valuable information can be obtained by using the signal readouts from more unit cells. However, if only a row or column of adjacent cells are used for evaluation, substrate integrated waveguides may not be needed for the non-evaluated unit cells. Still further, while the phase differences of adjacent cells were evaluated with respect to FIG. 9, information can be obtained from non-adjacent cells, e.g., phase differences between the first and third unit cells, the third and fifth unit cells and so on can be used to estimate an angle of arrival, although likely somewhat less accurately.

One or more example embodiments can be embodied in a system, such as described and represented herein. The system can include a reconfigurable intelligent surface that includes a unit cell that reflects an incoming electromagnetic signal as a reflected electromagnetic signal. The unit cell can include a reflective metallic element pattern that resonates at a frequency corresponding to the incoming electromagnetic signal, a variable tuning device, associated with the reflective metallic element pattern, that is controllable to alter a phase of the reflected electromagnetic signal, and a substrate supporting the reflective metallic element pattern. The unit cell can further include a ground plane beneath the substrate, a substrate integrated waveguide beneath the ground plane, including side vias that enclose sides of the substrate integrated waveguide (to ensure accurate waveguide operation at the designed frequency corresponding to the incoming electromagnetic signal), an upper metallic surface having an upper opening, and a lower metallic surface having a lower opening; the substrate integrated waveguide captures a portion of energy of the incoming electromagnetic signal through the upper opening. The unit cell can include a voltage or current via through the upper opening and the lower opening of the substrate integrated waveguide, and through the substrate, to provide positive power to a positive terminal of the variable tuning device, and a ground via through the substrate to ground a negative terminal of the variable tuning device. A coupled via probe of the unit cell extends into the substrate integrated waveguide through the lower opening, in which the coupled via probe is coupled to obtain at least some of the portion of the energy of the incoming electromagnetic signal. An electrical sensing contact is electrically coupled to the coupled via probe, the electrical sensing contact providing a signal readout representative of information of the incoming electromagnetic signal.

The upper metallic surface of the substrate integrated waveguide can include the ground of the reconfigurable intelligent surface (metasurface)/unit cell.

The electrical sensing contact can be coupled to logic that uses the signal readout to determine an angle of arrival of the incoming electromagnetic signal.

The electrical sensing contact can be a first electrical sensing contact of a first unit cell, and the signal readout can be a first signal readout representative of first phase information of the first unit cell. The system can further include a second electrical sensing contact of a second unit cell that provides a second signal readout representative of second phase information of the second unit cell; the first electrical sensing contact and the second electrical sensing contact can be coupled to logic that uses the first signal readout and the second signal readout to determine an angle of arrival of the incoming electromagnetic signal based on a phase differential value determined from a first phase angle corresponding to the first phase information and a second phase angle corresponding to the second phase information. The first unit cell can be horizontally adjacent or vertically adjacent to the second unit cell.

The electrical sensing contact can be coupled to logic that uses the signal readout to determine a magnitude value of the incoming electromagnetic signal.

The electrical sensing contact can be beneath the substrate integrated waveguide and electrically insulated from the substrate integrated waveguide.

The unit cell further can include a voltage contact coupled to the voltage or current via and beneath the substrate integrated waveguide.

The variable tuning device can include a varactor. The variable tuning device can include at least one of: a PIN diode, an array of fixed capacitors, an array of fixed inductors, or a capacitance tuning device with the capability of change the capacitance of each unit-cell.

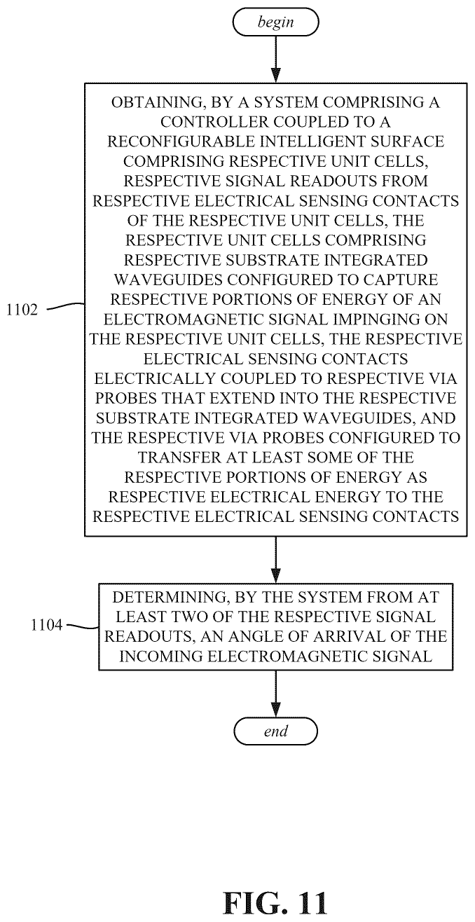

One or more example aspects, such as corresponding to example operations of a method, or a system/a machine-readable medium having executable instructions that, when executed by a processor, facilitate performance of the operations, are represented in FIG. 11. Example operation 1102 represents obtaining, by a system comprising a controller coupled to a reconfigurable intelligent surface comprising respective unit cells, respective signal readouts from respective electrical sensing contacts of the respective unit cells, the respective unit cells comprising respective substrate integrated waveguides configured to capture respective portions of energy of an electromagnetic signal impinging on the respective unit cells, the respective electrical sensing contacts electrically coupled to respective via probes that extend into the respective substrate integrated waveguides, and the respective via probes configured to transfer at least some of the respective portions of energy as respective electrical energy to the respective electrical sensing contacts. Example operation 1104 represents determining, by the system from at least two of the respective signal readouts, an angle of arrival of the incoming electromagnetic signal.

The respective unit cells of the reconfigurable intelligent surface can be arranged as an array comprising rows of the unit cells, the respective signal readouts can be representative of respective phase angles of the respective unit cells, and further operations can include, selecting, by the system from the respective unit cells, a row of the unit cells, in which the determining of the angle of arrival can include obtaining respective phase differential values, based on respective phase angle differences between respective pairs of at least part of the row of the unit cells, and estimating the angle of arrival based on the respective phase differential values.

Further operations can include selecting, by the system, the respective pairs of the unit cells based on respective pairs of adjacent cells in the row of the unit cells.

One or more example embodiments can be embodied in a unit cell, such as described and represented herein. The unit cell can include a reflective metallic element pattern that resonates at a frequency corresponding to an electromagnetic signal impinging on the unit cell. The unit cell can include a variable tuning device, associated with the reflective metallic element pattern, that is controllable to alter a phase of a redirected electromagnetic signal reflected by the unit cell, and a ground plane beneath the reflective metallic element pattern and electrically insulated from the reflective metallic element pattern, and electrically coupled to a negative terminal of the variable tuning device. The unit cell further can include a substrate integrated waveguide, comprising an upper metallic surface, side vias that enclose sides of the substrate integrated waveguide with respect to the frequency corresponding to the incoming electromagnetic signal, and a lower metallic surface, a voltage or current via through the substrate integrated waveguide, to provide positive power to a positive terminal of the variable tuning device, a coupled via probe extending into the substrate integrated waveguide, and an electrical sensing contact electrically coupled to the coupled via probe. The substrate integrated waveguide can include an opening in the upper metallic surface to transfer a portion of energy of the electromagnetic signal to the coupled via probe, to provide electrical energy representative of information of the incoming electromagnetic signal from the coupled via probe to the electrical sensing contact.

The voltage or current via can be coupled to a voltage contact of the unit cell, and the voltage or current via can pass through the substrate integrated waveguide through the opening in the upper metallic surface.

The substrate integrated waveguide can include the ground plane as the upper metallic surface.

As can be seen, the technology described herein is directed to an intelligent reconfigurable surface arranged with unit cells that can extract a small portion of the energy of an incoming electromagnetic wave, with most of the incoming electromagnetic wave reflected to an intended target. The extracted signal information can be used to determine channel information for the currently sensed environment, including the signal magnitude of the portion captured, and the angle of arrival of the incoming electromagnetic wave. This information can be used to adjust the phases of the unit cells to accurately determine the shape and/or direction of the reflected signal. Through a practical design based on substrate integrated waveguides, valuable current channel information can be estimated for use in improving the performance of intelligent reconfigurable surfaces.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a reconfigurable intelligent surface comprising a unit cell that reflects an incoming electromagnetic signal as a reflected electromagnetic signal, the unit cell comprising:
a reflective metallic element pattern that resonates at a frequency corresponding to the incoming electromagnetic signal;
a variable tuning device, associated with the reflective metallic element pattern, that is controllable to alter a phase of the reflected electromagnetic signal;
a substrate supporting the reflective metallic element pattern;
a ground plane beneath the substrate;
a substrate integrated waveguide beneath the ground plane, comprising side vias that enclose sides of the substrate integrated waveguide, an upper metallic surface having an upper opening, and a lower metallic surface having a lower opening, wherein the substrate integrated waveguide captures a portion of energy of the incoming electromagnetic signal through the upper opening;
a voltage or current via through the upper opening and the lower opening of the substrate integrated waveguide, and through the substrate, to provide positive power to a positive terminal of the variable tuning device;
a ground via through the substrate to ground a negative terminal of the variable tuning device;
a coupled via probe extending into the substrate integrated waveguide through the lower opening, the coupled via probe coupled to obtain at least some of the portion of the energy of the incoming electromagnetic signal; and
an electrical sensing contact electrically coupled to the coupled via probe, the electrical sensing contact providing a signal readout representative of information of the incoming electromagnetic signal.

2. The system of claim 1, wherein the upper metallic surface of the substrate integrated waveguide comprises the ground plane of the reconfigurable intelligent surface.

3. The system of claim 1, wherein the electrical sensing contact is coupled to logic that uses the signal readout to determine an angle of arrival of the incoming electromagnetic signal.

4. The system of claim 1, wherein the electrical sensing contact is a first electrical sensing contact of a first unit cell, wherein the signal readout is a first signal readout representative of first phase information of the first unit cell, and further comprising a second electrical sensing contact of a second unit cell that provides a second signal readout representative of second phase information of the second unit cell, wherein the first electrical sensing contact and the second electrical sensing contact are coupled to logic that uses the first signal readout and the second signal readout to determine an angle of arrival of the incoming electromagnetic signal based on a phase differential value determined from a first phase angle corresponding to the first phase information and a second phase angle corresponding to the second phase information.

5. The system of claim 4, wherein the first unit cell is horizontally adjacent or vertically adjacent to the second unit cell.

6. The system of claim 1, wherein the electrical sensing contact is coupled to logic that uses the signal readout to determine a magnitude value of the incoming electromagnetic signal.

7. The system of claim 1, wherein the electrical sensing contact is beneath the substrate integrated waveguide and is electrically insulated from the substrate integrated waveguide.

8. The system of claim 1, wherein the unit cell further comprises a voltage or current contact coupled to the voltage or current via and beneath the substrate integrated waveguide.

9. The system of claim 1, wherein the variable tuning device comprises a varactor.

10. The system of claim 1, wherein the variable tuning device comprises at least one of: a PIN diode, an array of fixed capacitors, an array of fixed inductors, or a capacitance tuning device.

11. A method, comprising:
obtaining, by a system comprising a controller coupled to a reconfigurable intelligent surface comprising respective unit cells, respective signal readouts from respective electrical sensing contacts of the respective unit cells, the respective unit cells comprising respective substrate integrated waveguides configured to capture respective portions of energy of an electromagnetic signal impinging on the respective unit cells, the respective electrical sensing contacts electrically coupled to respective via probes that extend into the respective substrate integrated waveguides, and the respective via probes configured to transfer at least some of the respective portions of energy as respective electrical energy to the respective electrical sensing contacts; and
determining, by the system from at least two of the respective signal readouts, an angle of arrival of the incoming electromagnetic signal.

12. The method of claim 11, wherein the respective unit cells of the reconfigurable intelligent surface are arranged as an array comprising rows of the unit cells, wherein the respective signal readouts are representative of respective phase angles of the respective unit cells, and further comprising, selecting, by the system from the respective unit cells, a row of the unit cells, wherein the determining of the angle of arrival comprises obtaining respective phase differential values, based on respective phase angle differences between respective pairs of at least part of the row of the unit cells, and estimating the angle of arrival based on the respective phase differential values.

13. The method of claim 12, further comprising selecting, by the system, the respective pairs of the unit cells based on respective pairs of adjacent cells in the row of the unit cells.

14. The method of claim 11, wherein the respective unit cells of the reconfigurable intelligent surface are arranged as an array comprising columns of the unit cells, wherein the respective signal readouts are representative of respective phase angles of the respective unit cells, and further comprising, selecting, by the system from the respective unit cells, a column of the unit cells, wherein the determining of the angle of arrival comprises obtaining respective phase differential values, based on respective phase angle differences between respective pairs of at least part of the column of the unit cells, and estimating the angle of arrival based on the respective phase differential values.

15. The method of claim 14, further comprising selecting, by the system, the respective pairs of the unit cells based on respective pairs of adjacent cells in the column of the unit cells.

16. The method of claim 11, further comprising, selecting, by the system from the respective unit cells, a first signal readout representative of first phase information of a first unit cell, and a second signal readout representative of second phase information of a second unit cell, wherein the determining of the angle of arrival comprises obtaining a phase differential value based on a first phase angle corresponding to the first phase information and a second phase angle corresponding to the second phase information, and estimating the angle of arrival based on the phase differential value.

17. The method of claim 11, further comprising determining, by the system from at least one of the signal readouts, a magnitude value of the incoming electromagnetic signal.

18. A unit cell, comprising:
a reflective metallic element pattern that resonates at a frequency corresponding to an electromagnetic signal impinging on the unit cell;
a variable tuning device, associated with the reflective metallic element pattern, that is controllable to alter a phase of a redirected electromagnetic signal reflected by the unit cell;
a ground plane beneath the reflective metallic element pattern and electrically insulated from the reflective metallic element pattern, and electrically coupled to a negative terminal of the variable tuning device;
a substrate integrated waveguide, comprising an upper metallic surface, side vias that enclose sides of the substrate integrated waveguide with respect to the frequency corresponding to the incoming electromagnetic signal, and a lower metallic surface;
a voltage or current via through the substrate integrated waveguide, to provide positive power to a positive terminal of the variable tuning device;
a coupled via probe extending into the substrate integrated waveguide; and
an electrical sensing contact electrically coupled to the coupled via probe,
wherein the substrate integrated waveguide comprises an opening in the upper metallic surface to transfer a portion of energy of the electromagnetic signal to the coupled via probe, to provide electrical energy representative of information of the incoming electromagnetic signal from the coupled via probe to the electrical sensing contact.

19. The unit cell of claim 18, wherein the voltage or current via is coupled to a voltage or current contact of the unit cell, and wherein the voltage or current via passes through the substrate integrated waveguide through the opening in the upper metallic surface.

20. The unit cell of claim 18, wherein the substrate integrated waveguide comprises the ground plane as the upper metallic surface.
